(19) United States
(12) Patent Application Publication
(10) Pub. No.: US 2011/0153826 A1
(43) Pub. Date: Jun. 23, 2011

(54) FAULT TOLERANT AND SCALABLE LOAD DISTRIBUTION OF RESOURCES

(75) Inventors: KRISHNAN ANANTHANARAYANAN, BOTHELL, WA (US); SHAUN D. COX, REDMOND, WA (US); VADIM EYDELMAN, BELLEVUE, WA (US); SANKARAN NARAYANAN, REDMOND, WA (US)

(73) Assignee: MICROSOFT CORPORATION, Redmond, WA (US)

(21) Appl. No.: 12/644,620

(22) Filed: Dec. 22, 2009

(51) Int. Cl. G06F 15/16

(52) U.S. Cl. 709/226

(57) ABSTRACT

A resource is located on a server using a distributed resource algorithm that is executing on each server within a cluster of servers. A request for a resource is received at a server in the cluster. The server executes the distributed resource algorithm to determine the server that owns the requested resource. The distributed resource algorithm automatically adapts itself to servers being added or removed within the cluster and is directed at evenly distributing resources across the available servers within the cluster.

### BACKGROUND

Fault tolerance and scalability are two requirements for server based systems. In a typical system, the server handles a set of resources and provides the ability to find a resource. For example, a file server provides the ability for users to store and look up files on the server. In a single server scenario, all of the resources are stored in a centralized location where. More servers may be utilized to serve resources. When a server goes down, those resources that are served by the server are affected.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A resource is located on a server using a distributed resource algorithm that is executed on each server within a cluster of servers. A request for a resource is received at any one of the servers in the cluster. The server receiving the request executes the distributed resource algorithm to determine the server that owns or handles the requested resource. The server handles the request when the server owns the resource or passes the request to the server that owns the resource. The distributed resource algorithm automatically adapts itself to servers being added or removed within the cluster and attempts to evenly distribute the resources across the available servers within the cluster.

### BRIEF DESCRIPTION OF THE DRAWINGS

FIG. 1 illustrates an exemplary computing environment;

FIG. 2 shows a system for locating resources in a cluster of servers;

FIG. 3 illustrates a process for assigning and mapping resources within a cluster of servers;

FIG. 4 shows an illustrative process for requesting a resource; and

FIG. 5 shows an illustrative process for requesting a resource that is temporarily handled by a backup server.

### DETAILED DESCRIPTION

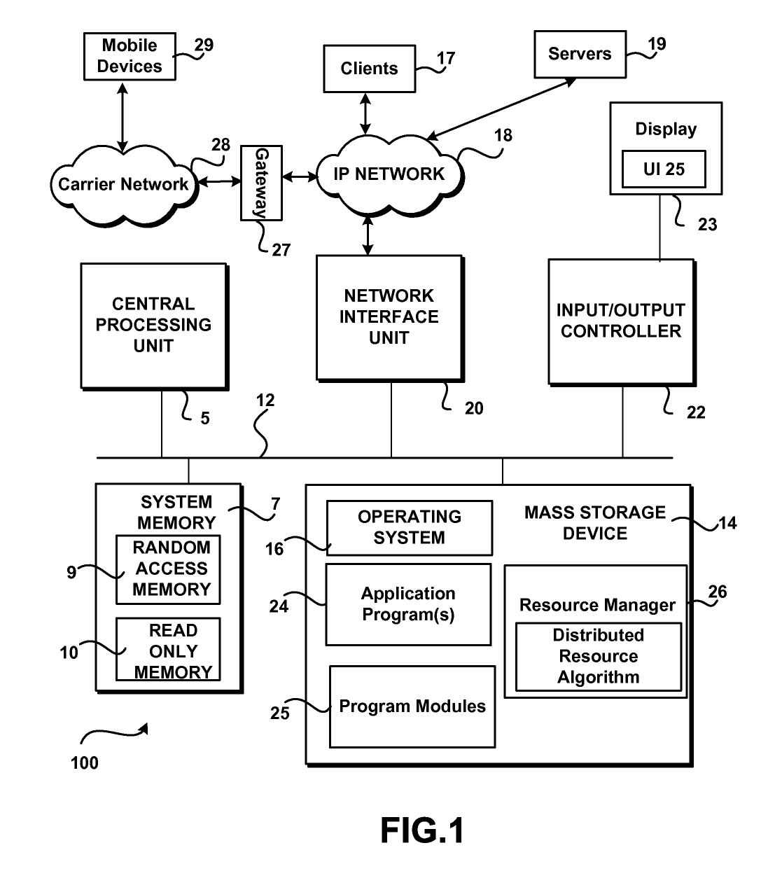

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 may be configured as a server, a desktop or mobile computer, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application program(s) 24, other program modules 25, and resource manager 26 which will be described in greater detail below.

The mass storage device 14 is connected to the CPU 5 through a mass storage controller (not shown) connected to the bus 12. The mass storage device 14 and its associated computer-readable media provide non-volatile non-transitory storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to an IP phone, a display screen 23, a printer, or other type of output device.

Carrier network 28 is a network responsible for communicating with mobile devices 29. The carrier network 28 may include both wireless and wired components. For example, carrier network 28 may include a cellular tower that is linked to a wired telephone network. Typically, the cellular tower carries communication to and from mobile devices, such as cell phones, notebooks, pocket PCs, long-distance communication links, and the like.

Gateway 27 routes messages between carrier network 28 and IP Network 18. For example, a call or some other message may be routed to a mobile device on carrier network 28 and/or route a call or some other message to a user's device on IP network 18. Gateway 27 provides a means for transporting the communication from the IP network to the carrier network. Conversely, a user with a device connected to a carrier network may be directing a call to a client on IP network 18.

As mentioned briefly above, a number of program modules and data files may be stored in the mass storage device 14 and RAM 9 of the computer 100, including an operating system 16 suitable for controlling the operation of a computer, such as OFFICE COMMUNICATION SERVER®, WINDOWS SERVER® or the WINDOWS 7® operating system from MICROSOFT CORPORATION of Redmond, Wash. The mass storage device 14 and RAM 9 may also store one or more program modules. In particular, the mass storage device 14 and the RAM 9 may store one or more application programs 24 and program modules 25.

Resource manager 26 is configured to locate a resource using a distributed resource algorithm that executed on each server within a cluster of servers. A request for a resource is received at a server. The server executes the distributed resource algorithm to determine the server that owns and handles the requested resource. The server handles the request when the server owns the resource or passes the request to the server that owns the resource. The distributed resource algorithm automatically adapts itself to servers being added or removed within the cluster and is directed at evenly distributing resources across the available servers within the cluster.

According to one embodiment, resource manager 26 communicates with an application program 24 such as MICROSOFT's OFFICE COMMUNICATOR®. While resource manager 26 is illustrated as an independent program, the functionality may be integrated into other software and/or hardware, such as MICROSOFT's OFFICE COMMUNICATOR®. The operation of resource manager 26 is described in more detail below. User Interface 25 may be utilized to interact with resource manager 26 and/or application programs 24.

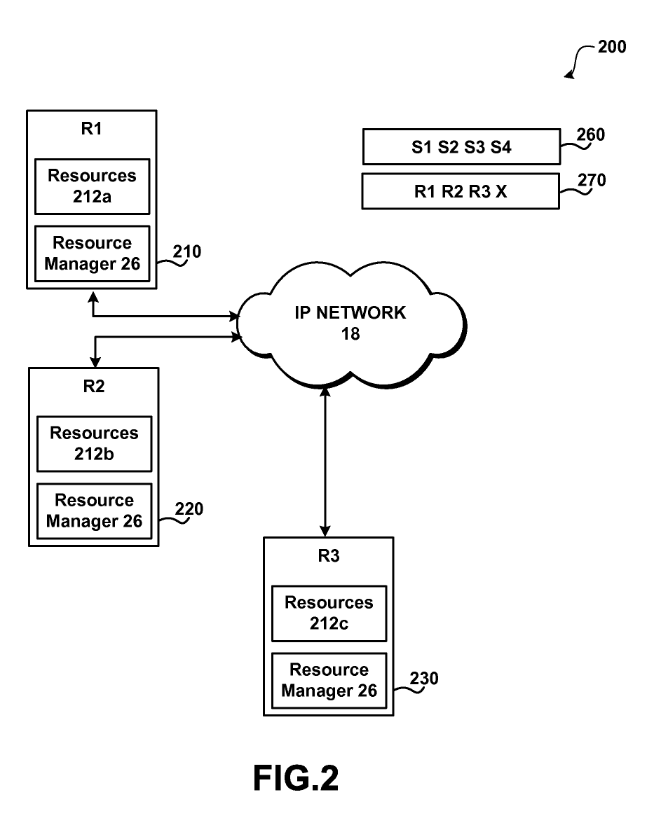

FIG. 2 shows a system for locating resources in a cluster of servers. As illustrated, system 200 includes a cluster of servers R1 (210), R2 (220) and R3 (230) that are coupled to IP Network 18. Each of the servers within the cluster includes a resource manager 26 that is used in locating a resource and owns and handles a set of resources (212a, 212b and 212c). As briefly discussed above, resource manager 26 is configured to locate a resource within the cluster by executing a distributed resource algorithm.

Within a cluster, a resource manager 26 on a server executes the distributed resource algorithm when a request is received at that server to locate a resource. A unique identifier is associated with each resource being located. The resource may be any type of resource, such as a file, a user, a mailbox, a directory, and the like. For example, the distributed resource algorithm may be used for Domain Name System (DNS) load balancing. According to one embodiment, the unique identifier when the resource is a user is based on the User's Uniform Resource Identifier (URI). The URI for the user may be used to determine the actual server that will service the user. For example, when a server receives a request from a user, the resource manager 26 for that server uses the URI to determine what server within the cluster is assigned to handle the user. When the resource is a file, the unique identifier may be based on a filename, a globally unique identifier (GUID), or some other unique identifier. Similarly, a Session Initiation Protocol (SIP) server could use a user's SIP URI as the unique identifier. Generally, any unique identifier may be used to identify each of the resources.

As illustrated, cluster 200 includes three physical servers (R1, R2 and R3). A list of logical servers 260 is also maintained. During a session for locating resources, the number of logical servers in a cluster remains constant. In the current example, there are four logical servers (S1, S2, S3, S4) as illustrated in box 260. A logical server represents a potential physical server, such as R1, R2 or R3 that could be in operation at any time. Each logical server does not have to correspond to the number of physical servers actually performing the distributed resource algorithm, but the number of physical servers is not more than the assigned number of logical servers during operation. The number of physical servers, however, may change while locating resources. For example, one or more of the physical servers (R1, R2, R3) may go down and come back up at any point during operation. The number of logical servers may be set to any number as long as it is at least equal to the number of physical servers that will be run during a session for locating resources. According to one embodiment, the number of logical servers is set to a maximum number of physical servers that will be available to locate resources.

For explanatory purposes that is not intended to be limiting, assume that the cluster has the four logical servers {S1, S2, S3, S4} (cardinality of 4) as illustrated by box 260. In the following example, assume that each of the resources is a user. Each resource is assigned a sequence to the logical servers that indicates the priority of the servers for handling that user. Assume that user Alice is assigned the sequence {S3, S4, S2, S1}. After assignment, this sequence does not change and is computed by each server in the same manner such that each server comes up with the same assigned sequence. In the current example, logical server S3 is primary server for Alice. S4 is the secondary server to be used when server S3 is unavailable. Server S2 is the tertiary server to be used when both S3 and S4 are unavailable, and S1 is the final server to handle the request for user Alice when no other servers are in operation.

During runtime, a runtime mapping 270 of the physical servers to the logical servers is maintained. For example when there are three physical servers R1, R2 and R3, they may be mapped to S1, S2 and S3 respectively. Any mapping, as long as it is consistent across servers, however, may be utilized. In this example, there is no physical server corresponding to logical server S4 and is represented by an X within box 270. Alice is assigned to R3 first (since S3 is the primary assigned logical server) and if R3 is unavailable then to R2 and then to R1.

During runtime, servers R1, R2 and R3 exchange health information through IP network 18 that allows each server to be aware of the health information of each of the other servers within the cluster. The health information can include different information. For example, the health could be determined by a simple heartbeat that each server that is alive automatically communicates at predetermined times (e.g. 1 second, ten seconds, one minute, etc) or include more detailed information within the communications. For instance, the health information could include a current state of the server, projected down times, and the like.

Assume that Alice is assigned to Server R3 since that happens to be the first server on the sequence for Alice. When R3 goes down, Alice re-connects. The other servers within the cluster know that R3 is unavailable based on the exchanged health information and R2 takes ownership of Alice since R2 is the first available physical server that is alive within the cluster and maps to the next logical server S2. When R1 needs to find the server owning the resource Alice, resource manager 26 runs the deterministic resource algorithm and determines that R2 is the first server on the physical list of Alice that is alive and forwards the request to R2.

When R3 comes back online as determined by the exchange of health information, the physical servers R1 and R2 that have been temporarily assigned resources from server R1 evaluate all the resources that they currently own. R2 determines that it is not the first server that is alive in the physical sequence for Alice and so migrates Alice back to R3.

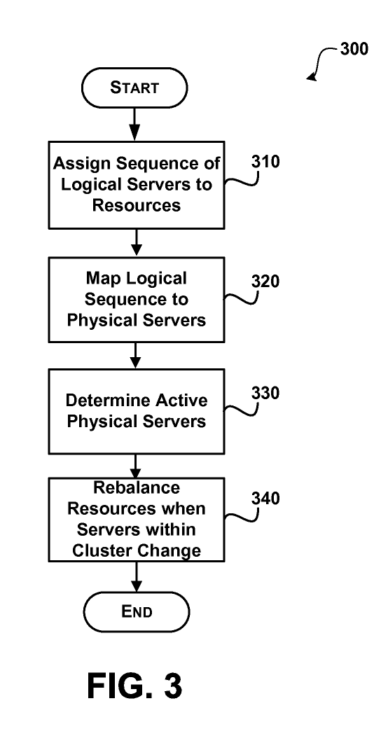

Referring now to FIGS. 3-5, illustrative processes for locating resources within a cluster of servers will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

Referring now to FIG. 3, a process 300 for assigning and mapping resources within a cluster of servers is shown.

After a start block, the process moves to operation 310, where an assignment of a sequence of servers is determined for each resource. Given a list of logical servers {S1, S2, . . . Sn} with cardinality n, a specific permutation of the sequence is determined for each resource. According to one embodiment, this deterministic permutation is keyed by the unique identifier of the resource. The first entry in the sequence is referred to as the primary server for the resource; the next entry is the secondary server for the resource, the third entry is the tertiary server for the resource, and so on. The use of logical servers allows the assigned sequence to remain the same for a resource even when new servers are added or servers are removed from the cluster. Generally, the assigned sequence should result in a fair distribution of the resources between the logical servers. For example, if there are one thousand resources and four logical servers then each logical server should be assigned approximately 250 resources.

The fairness of the distribution depends on the algorithm that is used for generating the logical sequence. Generally, an algorithm that results in an approximately equal distribution of resources between the logical servers should be utilized. An algorithm that is not fair can result in all the resources being assigned to the same server. For example if the algorithm generates the same sequence for all resources, then all of the resources will be assigned to the same server. According to one embodiment, Distributed Hash Tables (DHTs) are utilized. The use of DHTs yield the same results when executed on any server in the system and does not require a central coordinator. DHTs handle changes to server memberships within the cluster by executing a rebalancing algorithm. Generally, the resource's unique identifier is hashed to create an index number. The index number is then used to determine the server sequence for the resource (i.e. the primary server, secondary server . . . ).

The hash function maps the unique identifier for the resource to an integer in the range [1, N!], where N is the cardinality of the logical server set. For example, consider a cardinality of 3. With three logical servers, there are six possible assignments as listed below.

| | | | |
|---|---|---|---|
| 1 | S1 | S2 | S3 |
| 2 | S1 | S3 | S2 |
| 3 | S2 | S1 | S3 |
| 4 | S2 | S3 | S1 |
| 5 | S3 | S1 | S2 |
| 6 | S3 | S2 | S1 |

Thus given an integer between 1 and 3!=6, the logical mapping is obtained by doing a simple table lookup. As the cardinality goes up so does the size of the table (N! entries). An iterative approach may also be used for determining the assignment. As can be seen above, for indices of 1 and 2, the logical server in the most significant position is S1, for indices 3 and 4 it is S2 and for the rest of the indices it is S3. Once the first server has been fixed, the algorithm proceeds to the next position. According to one embodiment, the algorithm works from the most significant position to the least significant position.

Once the logical sequence has been computed for a given resource, the process moves to operation 320, where the logical sequence is mapped to a physical sequence. According to one embodiment, each server when it is commissioned is assigned an ID with each server having a different ID. According to one embodiment, a logical server is mapped to a physical server having the same ID as itself If a server that is assigned that ID is not present, then the logical server is mapped to a “Non-Existent” physical server (i.e. the X for S4 in FIG. 2).

To illustrate assignment of physical servers to the logical sequence of servers, assume that there are four servers commissioned and there are ten logical servers. The four physical servers are assigned ids 1, 2, 5 and 6. The logical mapping {S1, S2, S3, S4, S5, S6, S7, S8, S9, S10} is mapped to {R1, R2, X, X, R5, R6, X, X, X, X} where an X indicates a “Non-Existent” server. Thus the physical ID of a server is the same as the logical id for that server.

Once this mapping has been obtained, the process moves to operation 330, where the servers walk through the list from the beginning and check to see if each physical server is active. The request for the resource is then directed to the first physical server that is active. When the primary server for the resource is not available, then one of the backup servers owns the resource. According to one embodiment, a resource is accepted by a server in backup mode when the server is not the primary server for the resource. For example if the physical sequence for a resource is {R1, R2, X, X, R5, X, R7, X, X, X}, and if R1 is down then the resource is accepted by R2 in backup mode when R2 is not down. If R1 and R2 are both down, then the resource is accepted by R5 in backup mode. If on the other hand R1 is up, the resource is owned by the primary server at R1 and since there are no other servers before R1 the user is not considered to be in backup mode.

Moving to operation 340, the resources are rebalanced across the servers when the number of physical servers within the cluster changes. For example, when a server is added to the cluster then any resources that are being handled by one of the backup servers are evaluated to determine if they are to be moved to the server that came up. Resources that are being handled by the primary server are not affected by a non-primary server coming up.

Similarly, when a server is removed from the cluster, then all of the resources who are owned by the server that is removed are moved to another server within the cluster. This is done in two steps: Information about the server being de-commissioned is propagated to all the registrars in the cluster server. This causes subsequent requests for the resource to land on the correct server. All the resources assigned to the server being de-commissioned are disconnected when the server goes down. When a request for the resource occurs then it lands up on a different server in the cluster and are re-directed appropriately.

In order to reduce the number of reassignments of resources from occurring at the same time, the number of resources may be moved in a batched mode. For example, instead of handling all of the requests to move the resources at the same time, a predetermined number (i.e. 25, 50, 100, etc. . . . ) may be handled at a time. When a physical server goes down, all resources that are assigned to that physical server are moved to another server. Similarly, when the server is assigned to handle users, then another server is assigned to handle the user. Since health information is exchanged between servers in the cluster, the resources are moved to the next available server in the logical sequence for the resource and that server now owns that resource until the resource is moved again (i.e. the server comes back up).

When a server comes back online, all the servers detect this and re-evaluate the resources that they own. If the physical server that came up comes before the physical server on which the resource is, the resource is migrated to the correct physical server.

The process then flows to an end block and returns to processing other actions.

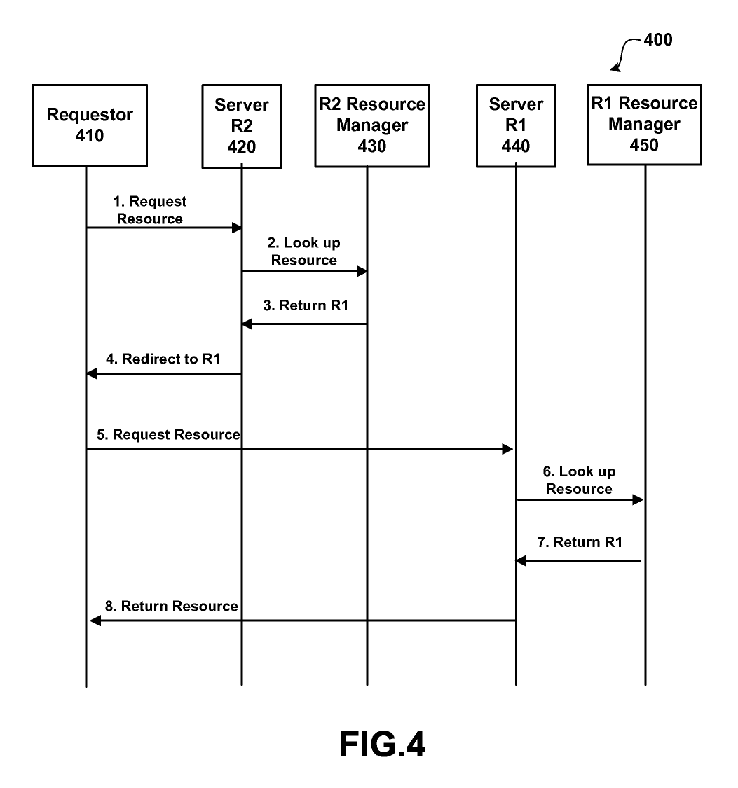

FIG. 4 shows an illustrative process for requesting a resource. As illustrated, process 400 includes requestor 410, server R2 (420), R2 Resource Manager 430, Server R1 (440) and R1 Resource Manager (450). While two physical servers are illustrated, there may be more or fewer physical servers. For example, there may be up to the number of logical servers. For purposes of the following example, assume that a resource has been assigned a logical sequence of {S4, S1, S2, S3, S5, S6, S8, S7, S9, S10}.

At step 1, the requestor 410 requests a resource that is received on server R2. At step, 2, R2 queries the R2 resource manager to obtain the server that is handling the resource. At step 3, the R2 resource manager returns that server R1 is the server that currently owns the resource. Since servers R1 and R2 are both in the same cluster, server R2 sends a redirect to the requestor at step 4. The requestor requests the resource from server R1 at step 5. Server R1 queries the R1 Resource Manager to determine the server handling the resource. In this case, server R1 is handling the resource and therefore, the R1 resource manager returns that server R1 is handling resource at step 7. At step 8, server R1 returns the requested resource to the requestor.

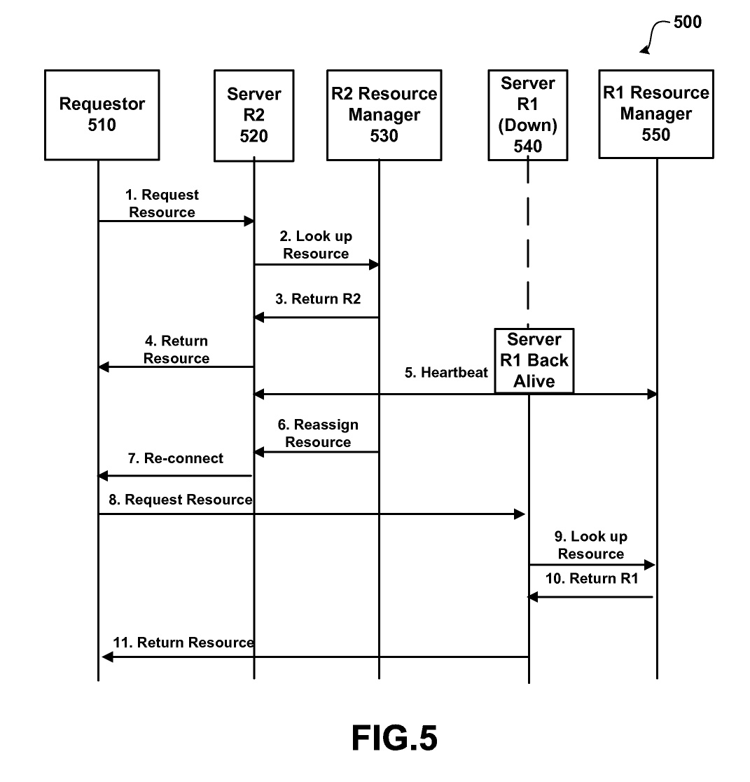

FIG. 5 shows an illustrative process for requesting a resource that is temporarily handled by a backup server. As illustrated, process 500 includes requestor 510, server R2 (520), R2 Resource Manager 530, Server R1 (540) and R1 Resource Manager (550). For purposes of the following example, assume that a resource has been assigned a logical sequence of {S4, S1, S2, S3, S5, S6, S8, S7, S9, S10}.

In this example, in step 1 requestor 510 requests a resource that is received by server R2. In this example, server R1 is the primary server, but R1 is down at the time of the request. At step 2, server R2 requests R2 resource manager to look up who owns the requested resource. Since the primary server is down, the R2 resource manager returns that R2 owns the resource. At step 4, the resource is returned to the requestor. At step 5, health information (i.e. a heartbeat) is received at server R2 indicating that R1 is back online. This causes R2 resource manager at step 6 to migrate the resource back to R1 which is the primary server for the resource. At step 7, when the resource is a user, the user is required to re-connect to the cluster. At step 8, the requestor requests the resource from server 1. At step 9, server R1 requests R1 resource manager to look up who owns the requested resource. The R1 resource manager returns the R1 as the owner of the resource at step 10. At step 11, the resource is returned to the requestor.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for determining a server from a cluster of servers to handle a resource request, comprising:
receiving a request for a resource on a server within the cluster of servers;
executing a distributed algorithm on the server receiving the request for the resource to determine a server that handles the resource; wherein the distributed algorithm is also performed on each of the other servers within the cluster when one of the other servers receives the request for the resource; wherein the distributed algorithm uses a list of logical servers and a mapping of the logical servers to the servers within the cluster that are active;
forwarding the request to the determined server when the resource is not handled by the server; and
responding to the request for the resource when the server receiving the request handles the resource.

2. The method of claim 1, further comprising assigning a resource to a list of logical servers that indicates a preferred server for handling the resource and when the preferred server is not available another predetermined logical server handling the resource.

3. The method of claim 1, wherein a number of logical servers within the cluster is a fixed number and wherein a number of the servers within the cluster is equal to or less than the number of logical servers.

4. The method of claim 1, wherein the mapping of the logical servers to the servers within the cluster is updated periodically.

5. The method of claim 1, wherein each of the servers periodically exchange health information with each other.

6. The method of claim 4, wherein the mapping is updated based on a health of the servers within the cluster.

7. The method of claim 1, further comprising determining when a server is added to the cluster and in response to the server being added, each server within the cluster re-evaluating its assigned resources.

8. The method of claim 1, further comprising determining when a server is removed from the cluster and in response to the server being removed, assigning the resources that are assigned to the removed server to other servers within the cluster based on the list of logical servers.

9. The method of claim 1, wherein the resources are uniformly distributed to the servers using a distributed hash table.

10. A non-transitory computer-readable storage medium having computer-executable instructions for determining a server from a cluster of servers to handle a resource request, comprising:
receiving at a server within the cluster a request for a resource;
on the server, executing a distributed algorithm to determine a server that handles the resource; wherein the distributed algorithm is also performed on each of the other servers within the cluster in response to another request for the resource; wherein the distributed algorithm uses a unique identifier that is associated with the resource, a list of logical servers and a mapping of the logical servers to the servers within the cluster that are active; wherein the resource is assigned a sequence indicating a priority among the servers within the cluster to handle the request;
forwarding the request to the determined server when the resource is not handled by the server; and
responding to the request for the resource when the server receiving the request owns the resource.

11. The computer-readable storage medium of claim 10, wherein a number of logical servers within the cluster is a fixed number and wherein a number of the servers within the cluster is equal to or less than the number of logical servers during a runtime operation and wherein the mapping of the logical servers to the servers within the cluster is updated periodically during the runtime.

12. The computer-readable storage medium of claim 10, wherein each of the servers periodically exchange health information with each other to determine when a server is removed from the cluster and when a server is added to the cluster.

13. The computer-readable storage medium of claim 12, in response to the server being added and the server being removed, each server within the cluster re-evaluating and re-balancing its assigned resources with the other servers within the cluster.

14. The computer-readable storage medium of claim 10, wherein the resources are uniformly distributed to the servers within the cluster using a distributed hash function.

15. The computer-readable storage medium of claim 10, wherein the resources handled by the servers are users within a VoIP communication system.

16. A system for determining a server from a cluster of servers to handle a resource request, comprising:
a network connection that is configured to connect to the IP network;
a processor and a computer-readable medium;
an operating environment stored on the computer-readable medium and executing on the processor; and
a resource manager operating under the control of the operating environment and operative to:
receive a request for a resource;
execute a distributed algorithm to determine the server within the cluster that handles the resource; wherein the distributed algorithm is also performed on each of the other servers within the cluster in response to another request for the resource; wherein the distributed algorithm uses a unique identifier that is associated with the resource, a list of logical servers and a mapping of the logical servers to the servers within the cluster that are active; wherein the resource is assigned a sequence indicating a priority among the servers within the cluster to handle the request;
forward the request to the determined server when the resource is not handled by the server receiving the request; and
respond to the request for the resource when the server receiving the request owns the resource.

17. The system of claim 16, wherein a number of logical servers within the cluster is a fixed number that does not change during a runtime and wherein a number of the servers within the cluster is equal to or less than the number of logical servers during the runtime and wherein the mapping of the logical servers to the servers within the cluster is updated periodically during the runtime.

18. The system of claim 16, wherein the resource manager further comprises periodically exchanging health information with the servers within the cluster to determine when a server is removed from the cluster and when a server is added to the cluster.

19. The system of claim 16, in response to a server being added and the server being removed, each server within the cluster re-evaluating and re-balancing its assigned resources with the other servers within the cluster.

20. The system of claim 16, wherein the resources are uniformly distributed to the servers within the cluster using a hash function.
